(19) United States
(12) Patent Application Publication
(10) Pub. No.: US 2007/0113607 A1
(43) Pub. Date: May 24, 2007

(54) Indicator of a keylock

(76) Inventor: Chien-Yung Huang, Banchiao City (TW)

Correspondence Address: PRO-TECHTOR INTERNATIONAL SERVICES, 20775 NORADA CT., SARATOGA, CA, 95070, US

(21) Appl. No.: 11/527,340

(22) Filed: Sep. 26, 2006

(30) Foreign Application Priority Data
Nov. 22, 2005 (TW) 094220205

(51) Int. Cl. E05B 41/00

(52) U.S. Cl. 70/432

(57) ABSTRACT

A keylock that can be opened either by a key A or by a key B, having an indicator for indicating whether the keylock has been opened by said key B, and including a housing and a stopper that is movable relative to the housing between a locked position and unlocked position when the keylock is opened by said key B or by said key A, wherein the indicator includes an indicator member connected to the housing for movement between first and second positions and being capable of displaying a first surface that is viewable through a window of the housing when the indicator member is in the first position, and of displaying a second surface through the window when in the second position, with the first and second surfaces differing in appearance one from the other.

### BACKGROUND OF THE INVENTION

(a) Field of the Invention

The present invention relates to the indicator of a keylock, more particularly, a keylock that can be opened either by a key A or by a key B, having an indicator for indicating whether the keylock has been opened by said key B, wherein the indicator is capable of displaying a normal first state and a second state.

(b) Description of the Prior Art

A conventional keylock is only provided with a one-way function of unlocking and locking. As a change of diversified society, this single-function keylock has not been able to satisfy a part of practicers. For example, most of dedicated safe boxes of companies are emplaced with money, valuable objects, or classified documents. If the keylock of the safe box only provides for an opening and closing by a single key, then cashiers and auditors will not be able to manage those objects, and the cashiers will not be able to confirm the objects which have been audited by the auditors. Accordingly, it is indeed necessary to improve the aforementioned conventional keylocks of the safe boxes.

### SUMMARY OF THE INVENTION

The present invention related to the indicator of a keylock, namely to providing such keylocks with an indicator window in a housing, with the indicator window displaying the indicators of different colors. When users use different keys to unlock the keylock to drive a key tumbler to rotate towards a left or a right, the indicator of different colors in the indicator window will display a current state of the keylock.

### BRIEF DESCRIPTION OF THE DRAWINGS

FIG. 1 is a perspective view of the present invention;

FIG. 1˜1 is a perspective exploded view of the present invention;

FIG. 2 is a cross section view of the present invention when in a locking position;

FIG. 2˜1 is a bottom view of the tumbler of the present invention when in a locking position;

FIG. 3 is a cross section view of the present invention when in an unlocking position, and with the lock opened by key B;

FIG. 3˜1 is a bottom view of the present invention when in an unlocking position, and with the lock opened by key B;

FIG. 4 is a cross section view of the present invention when in a locking position;

FIG. 4˜1 is a bottom view of the tumbler of the present invention when in a locking position;

FIG. 5 is a cross section view of the present invention when in an unlocking position, and with the lock opened by key A, and the key tumbler in small angle;

FIG. 5˜1 is a bottom view of the present invention when in an unlocking position, and with the lock opened by key A, and the key tumbler in small angle;

FIG. 6 is a cross section view of the present invention when in an unlocking position, and with the lock opened by key A, and the key tumbler in wide angle;

FIG. 6˜1 is a bottom view of the present invention when in an unlocking position, and with the lock opened by key A, and the key tumbler in wide angle;

FIG. 7 is a cross section view of the present invention when in a locking position; and

FIG. 7˜1 is a bottom view of the tumbler of the present invention when in a locking position.

### DETAILED DESCRIPTION OF THE PREFERRED EMBODIMENTS

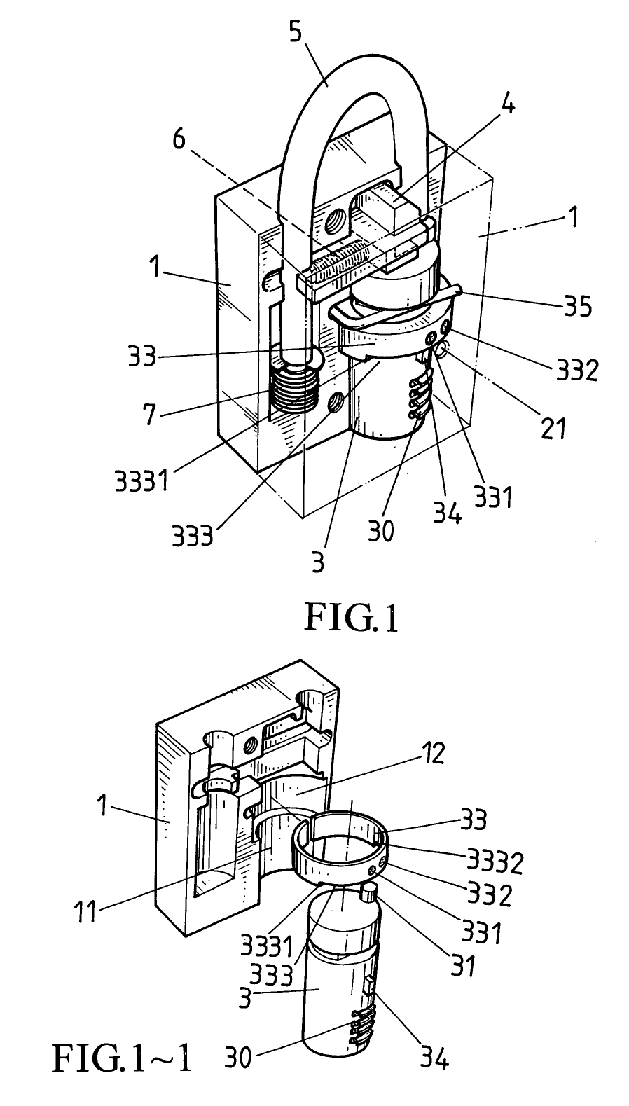

Referring to FIG. 1, the present invention comprises a housing 1, a key tumbler 3, a stopper 4, a shackle 5 and two springs 6, 7; wherein an interior of the housing 1 is provided with a space for emplacing the key tumbler 3, stopper 4, two springs 6,7, and a part of the shackle Referring to FIG. 1˜1, a longitudinal sink 11 of the housing 1 is latched with the key tumbler 3, a top end of the key tumbler 3 which is provided with a plurality of rows of plates 30 is provided with a pushing block 31, and a bottom end of the key tumbler 3 is provided with a keyhole 32 (as shown in FIG. 3˜1). An end of the pushing block 31 can be abutted at an end of the stopper 4, the other end of stopper 4 can squeeze the spring 6, a bottom of an end of the shackle 5 can squeeze the other spring 7, and the other end of shackle 5 is provided with a hook-hole 51 having a slant corner (as shown in FIG. 3) for locking a slant locking block 41 of the stopper 4. The present invention is provided with the characteristics as follows.

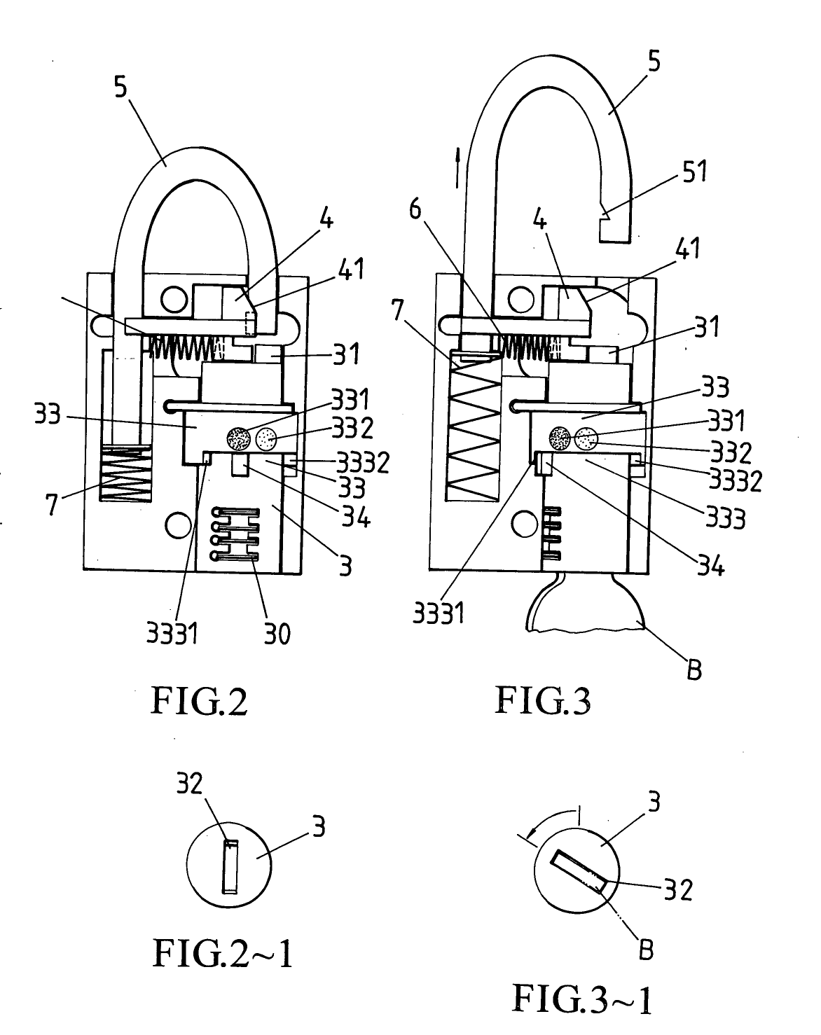

A transversal sink 12 of the housing 1 can be emplaced with an indicator 33 (as shown in FIG. 1˜1), the round-shape indicator 33 can provide for a transfixing of the key tumbler 3, the indicator 33 is provided with a first surface 331 and second surface 332 of two different colors, and a bottom of the indicator 33 is provided with a notch 333 having walls 3331, 3332 at two ends of the notch 333. A pusher 34 is located on the key tumbler 3, at a position relative to the notch 333. Referring to FIG. 2, the pusher 34 can be displaced in the notch 333. Moreover, a top of the indicator 33 is provide with a U-shape spring clip 35 which is used to clip the key tumbler 3 for limiting a position when it is rotating. On the other hand, an indicator window 21 is located on the housing 1, and the indicator window 21 is aligned with the first surface 331 of the second surface 332 on the indicator 33.

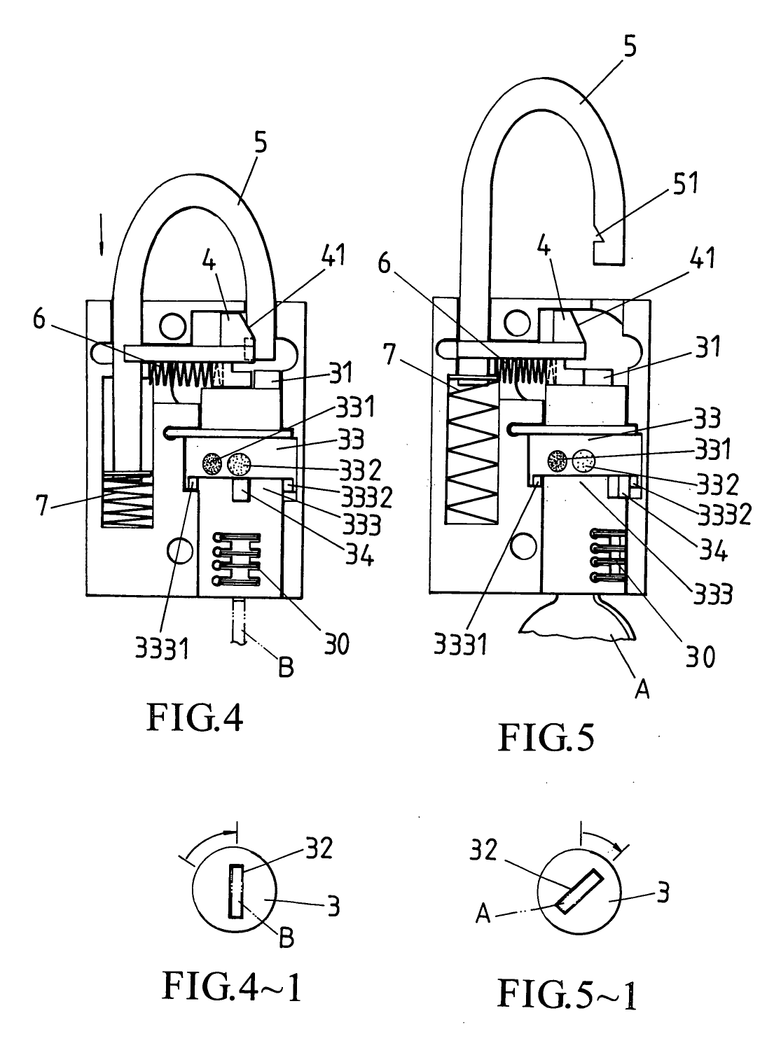

Referring to FIGS. 2 and 2˜1, it shows the keylock in a locking position, wherein a color of green will be shown on the first surface 331 when viewing from the indicator window 21, and the keyhole 32 of key tumbler 3 is in a vertical condition. A company auditor can turn a key B left (it cannot be turned right) to unlock the keylock. Referring to FIGS. 3 and 3˜1, the keyhole 32 of key tumbler 3 is turned left to manifest a slant condition, and the pushing rod 31 of key tumbler 3 pushes the stopper 4 and squeezes the spring 6, enabling the locking block 41 to escape from the hook-hole 51 of shackle 5, and the spring 7 of shackle 5 to eject the shackle 5 upward for forming an unlocking position. At this time, the pusher 34 of key tumbler 3 is turned left and pushes a wall 3331 at a left of the notch to drive the indicator 33 to rotate, and a color of red will be shown on the second surface 332 when viewing from the indicator window 21. The auditor opens a safe box and reconciles, and stamps on a check list to notify that objects in the safe box have been reconciled. Referring to FIGS. 4 and 4˜1, the auditor uses the key B to turn the key tumbler 3 right to its original position (at this time, the pusher 34 is restored to a center position), pulls out the key B, and then presses in the shackle 5 for locking the keylock.

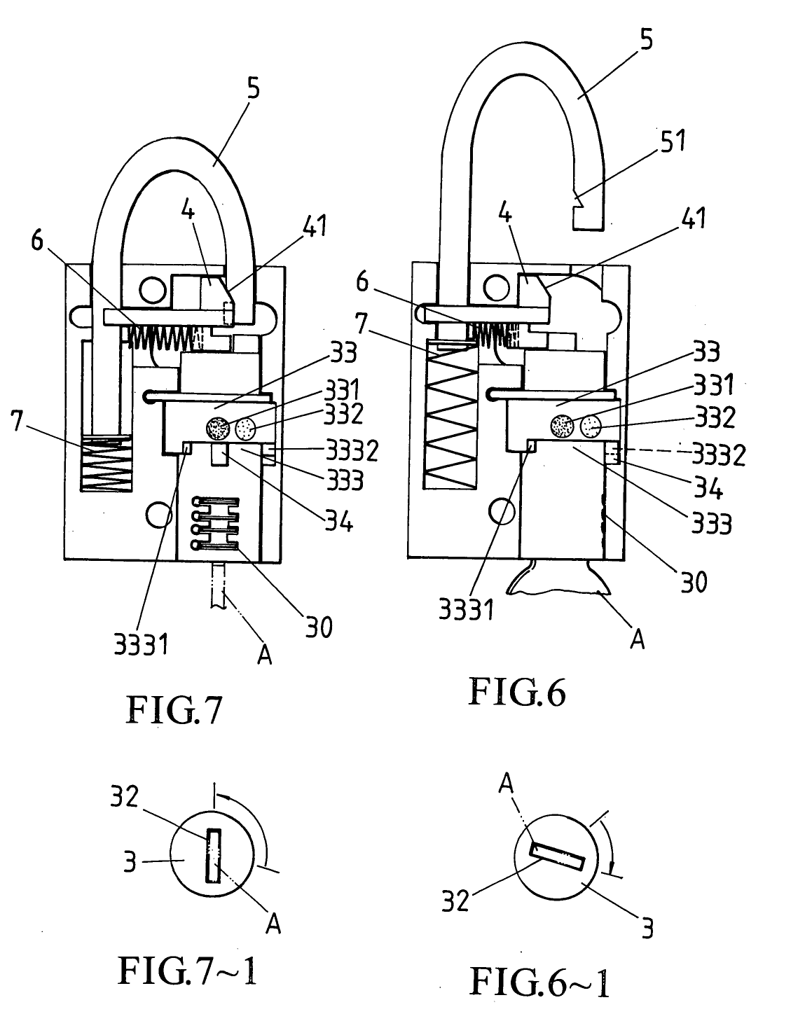

When a company cashier takes back the safe box, he or she can know that the auditor has proceeded with the reconciliation by observing the color of red on the second surface 332 when viewing from the indicator window 21. Referring to FIGS. 5 and 5˜1, in order to look at the reconciliation information and the check list, the company cashier inserts the key A into the key tumbler 3 and turns it right (it cannot be turned left) to unlock the keylock, such that the keyhole 32 manifests a slant condition towards right. At this time, the pusher 34 is deflected towards right, but is not abutted the wall 3332 at a right side of the indicator 33 in a small angle (as shown in FIG. 5˜1). Therefore, the color of red will still be shown on the second surface 332 when viewing from the indicator window 21. After correctly checking by the cashier, referring to FIGS. 6 and 6˜1, he or she turns right the key A to a wide angle (the keylock is still opened), and the pusher 34 of key tumbler 3 is turned right to push the wall 3332 at the right side of indicator 33 for driving the indicator 33 to rotate. Therefore, the color on the first surface will be changed from red to green, when viewing from the indicator window 21. Referring to FIGS. 7 and 7˜1, finally, the cashier uses this key A and turns it left to an original position such that the keyhole 32 manifests a vertical position, and presses in the shackle 5 to lock the keylock, until a next auditing by the auditor.

In addition, the indicator 33 of present invention can be designed as a C-shape ring with elasticity to respond to a resistant force generated by an inner wall of the sink 12 of housing 1. When the housing 1 is squeezed by elastic force of itself or is subjected to external force, the indicator 33 will not rotate freely (having a certain amount of resistant force), and the first and second surfaces 331, 332 are of different colors.

As will be apparent from the foregoing, the present invention having an indicator window in the housing, in the indicator window the first and second surfaces are of different colors, when the key brings to key tumbler to rotate at a same time, it can bring the indicator to rotate. When viewing from the indicator window, different colors are displayed on the first and second surfaces to manifest the state at that time.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A keylock that can be opened either by a key A or by a key B, having an indicator for indicating whether the keylock has been opened by said key B, wherein the indicator is capable of displaying a normal first state and a second state, and wherein the indicator displays the first state until the indicator is switched to displaying the second state as the result of the keylock being opened by said key B, and wherein the indicator is resettable from displaying the second state to displaying the first state only after the keylock is opened by said key A.

2. A keylock that can be opened either by a key A or by a key B, having an indicator for indicating whether the keylock has been opened by said key B, and including a housing and a stopper that is movable relative to the housing between a locked position and unlocked position when the keylock is opened by said key B or by said key A, wherein the indicator includes an indicator member connected to the housing for movement between first and second positions and being capable of displaying a first surface that is viewable through a window of the housing when the indicator member is in the first position, and of displaying a second surface through the window when in the second position, with the first and second surfaces differing in appearance one from the other.

3. The keylock of claim 2 wherein the first and second surfaces are of different colors.

4. The keylock of claim 2 wherein the first surface the color green, and the second surfaces displays the color red.
